(19) United States
(12) Patent Application Publication
(10) Pub. No.: US 2002/0116850 A1
(43) Pub. Date: Aug. 29, 2002

(54) Hanging assembly for displaying posters and a storage assembly for same

(76) Inventor: Barbara Ryan, Chicago, IL (US)

Correspondence Address: GREER, BURNS & CRAIN, 300 S WACKER DR, 25TH FLOOR, CHICAGO, IL, 60606, US

(21) Appl. No.: 09/795,843

(22) Filed: Feb. 28, 2001

(51) Int. Cl. G09F 7/22

(52) U.S. Cl. 40/617

(57) ABSTRACT

A system for displaying and storing sheets including printed information thereon, as well as the components of the system separately. The system includes a plurality of relatively rigid sheets with the printed information thereon, a mounting fixture for displaying at least one sheet, and a hanging bar for storing the sheets not being used. Specifically, the mounting fixture includes an elongated bar, means for attaching the elongated bar to a wall, and a plurality of hooks. The hanging bar includes a rod, an upper hook configured for hanging the bar upon a pole, and at least two generally S-shaped hooks attached to the rod. The S-shaped hooks are designed to receive the sheets not being displayed. The printed information may include word puzzles, rebuses, gramograms, doodles, etc. If the information is a type of puzzle, a separate answer key is also preferably provided as part of the system.

The present invention relates generally to devices for hanging and storing sheets with printed information thereon, and more particularly to a mounting fixture for displaying a sheet that provides secure mounting for a sheet that can be installed by a user situated well below the fixture, as well as to a hanging bar that allows the sheets not being displayed on the mounting fixture to be stored in a closet.

### BACKGROUND OF THE INVENTION

Numerous different types of prior art devices are available for displaying posters, maps or other types of sheets with printed material thereon. For example, many office supply stores sell framed strips of cork board within which push pins or thumb tacks can be inserted for displaying posters. One problem with such devices is that the user must be able to reach the framed strip to insert the push pins. Accordingly, the frame is normally portioned on a wall at a height that is low enough for the user to easily reach. However, such low positioning limits the visibility of the material being displayed, especially for those at the other end of the room where the frame is located. Alternatively, the frame could be positioned at a suitable height that allows better visibility. However, such higher positioning of the frame then requires the use of a ladder or chair to enable the user to reach the frame for mounting the poster. Besides the inconvenience associated with hauling a ladder or chair to the proper location, climbing upon such devices may lead to injury from an accidental fall.

Other drawbacks of this cork frame and push pin system are that the push pins frequently become lost or are not strong enough to securely maintain the poster in the mounted position. In cases where the poster is too heavy to be securely mounted, either the poster is not displayed or an alternate mounting device is required. Thus, the user is inconvenienced by having to obtain additional push pins and/or an alternate mounting device.

A second popular type of display apparatus is commonly referred to as a map rail. Map rails typically include a cork strip, similar to that described above (and with similar drawbacks) and a number of flip chart hook/clips that are to be attached to the map rail. The flip chart hook/clips are configured as a combination of a hook and a clip, where the hook portion is used for hanging heavier materials and the clip portion is used for lighter materials. The hook portion is generally U-shaped and can be inserted within holes that are formed on the map or other material being displayed. The clip portion does not require that holes be formed in the map, and instead simply grasps the edge of the map within two fingers that are biased together.

One problem with this type of device is that the hook/clips do not provide enough support for the material being displayed. If someone bumps into the material being displayed, the clip portion (if being used) often looses its grip and the hook portion (if being used) often becomes separated from the frame. In either case, the material being displayed will fall from the display apparatus.

An additional problem of this system is that the maps or other material being displayed are normally relatively flimsy (which enables them to be rolled up to facilitate storage). Accordingly, when installing these materials upon the map rail, the user must grasp the top portion of the map and position it upon either the hooks or the clips. Thus, as with the cork frame device described above, the user must be able to reach the map rail during installation of the map. Similar drawbacks to those described with regard to the cork frame are thus also encountered with this device (i.e., the rail must be installed at a height that is lower than the optimal viewing height or a chair or ladder is required to access the rail).

Accordingly, one object of the present invention is to provide an improved mounting fixture for securely displaying sheets with information printed thereon.

Another object of the present invention is to provide an improved mounting fixture that does not require the use of additional separate components, such as push pins, that can become lost or misplaced.

Another object of the present invention is to provide an improved system for displaying printed information that includes a mounting fixture and a plurality of relatively rigid sheets that can be easily attached to the mounting fixture from below the level of the mounting fixture, even if the fixture is positioned well above the height of the user.

Yet another object of the present invention is to provide an improved system for displaying printed information where the information is displayed upon a plurality of laminated sheets, and also where the laminated sheets include a feature for preventing unauthorized duplication with a photocopier.

Still another object of the present invention is to provide an improved system for displaying and storing sheets with printed information thereon, where the sheets not being displayed can be stored in a closet upon a hanging bar that only utilizes approximately the same amount of space required to hang a garment.

These and other objects of the present invention are discussed or will be apparent from the following detailed description of the present invention.

### BRIEF SUMMARY OF THE INVENTION

The above-listed objects are met or exceeded by the present devices and system for storing and displaying sheets with printed information thereon, which features a mounting fixture, a hanging bar, and a plurality of relatively rigid sheets.

More specifically, the present invention provides a mounting fixture for displaying a sheet including printed information thereon. The fixture includes an elongated bar including a front surface, a rear surface and two end surfaces, means for attaching the elongated bar to a wall, and a plurality of hooks attached to the front surface of the elongated bar, with each of the hooks being generally L-shaped.

The present invention also provides a system for displaying and storing sheets including printed information thereon, where the system includes a plurality of relatively rigid sheets including the printed information thereon, a mounting fixture for displaying at least one of the sheets, and a hanging bar for storing the sheets not being displayed on the mounting fixture. In particular, the mounting fixture includes an elongated bar, means for attaching the elongated bar to a wall, and a plurality of hooks attached to the front surface of the elongated bar. Also, the hanging bar includes a rod, an upper hook configured and arranged for hanging the hanging bar upon a horizontal pole within a closet, and at least two generally S-shaped hooks attached to the rod. The generally S-shaped hooks are configured and arranged for receiving thereon the relatively rigid sheets not being displayed.

### BRIEF DESCRIPTION OF THE SEVERAL VIEWS OF THE DRAWINGS

One example of a preferred embodiment of the present invention is shown herein with reference to the drawings wherein:

FIG. 1 shows a perspective view of the present mounting fixture and a sheet including printed information thereon;

FIG. 2 is a side view of the mounting fixture of FIG. 1;

FIG. 3 is a perspective view of an answer key for use with the present invention when the printed material includes word puzzles, rebuses, gramograms or doodles;

FIG. 4 is a perspective view of a hanging bar for storing the sheets not being displayed upon the mounting fixture; and

FIG. 5 is a side view of the hanging bar of FIG. 4.

### DETAILED DESCRIPTION OF THE INVENTION

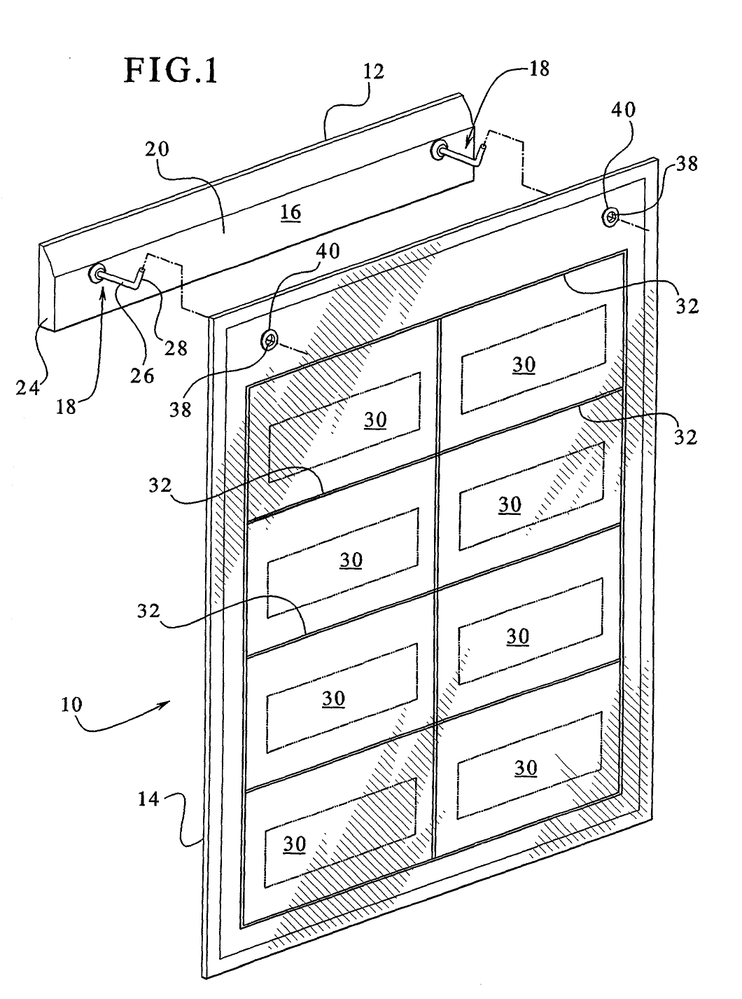

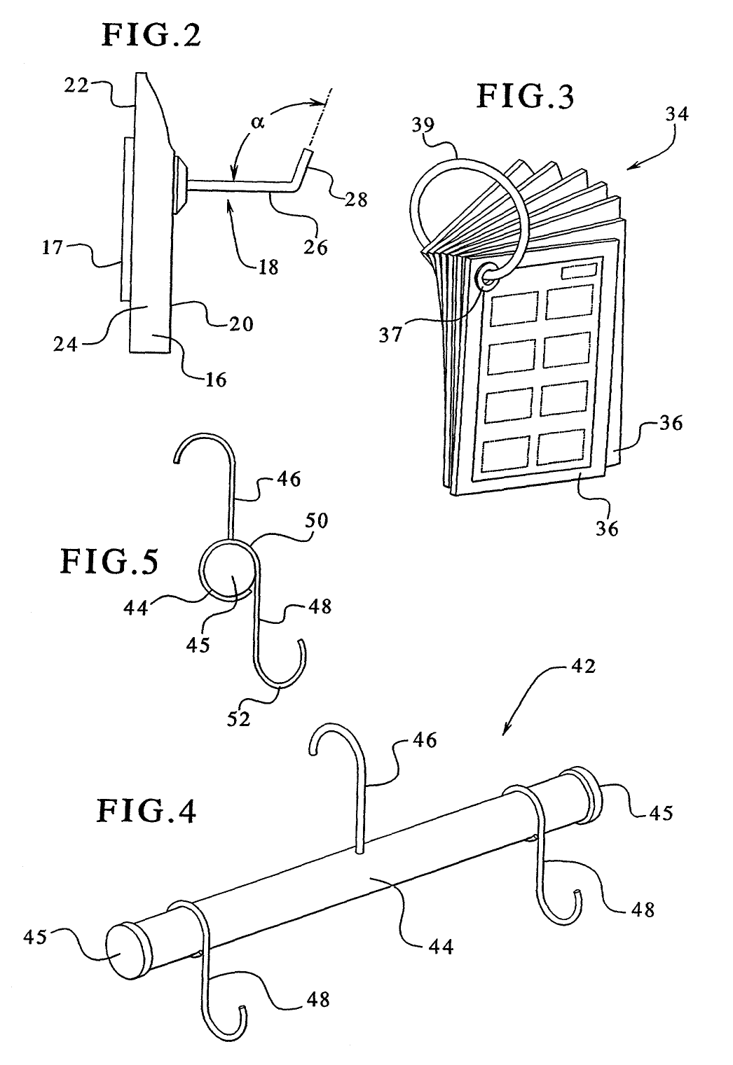

Referring now to FIG. 1, one example of an embodiment of the present system for displaying a sheet with printed information thereon is shown as index number 10. This system 10 includes a mounting fixture 12 that preferably comprises an elongated bar 16 that is defined by a front surface 20, a rear surface 22 (FIG. 2), and two end surfaces 24. At least one, and preferably two (or more), hooks 18 are attached to the front surface 20 of the bar 16. The rear surface 22 of the elongated bar 16 preferably includes a means for attaching the bar 16 to the wall or other surface that it is intended to be affixed upon. In the preferred embodiment, the bar 16 includes two double sided adhesive pads 17 (one of which is shown in FIG. 2). For optimal stability, one pad 17 is preferably placed directly behind each of the hooks 18. Of course, other attaching means besides adhesive pads are also contemplated as being within the scope of the invention (such as using a picture hook and wire arrangement, Velcro® brand pads, nails, screws, rope loops, etc.).

In this preferred embodiment of FIG. 1, the hooks 18 are generally L-shaped, and include a first portion, or first leg, 26 and a second portion, or second leg, 28. As best shown in FIG. 2, the second leg 28 is preferably shorter than the first leg 26. Although other dimensions are contemplated as being within the scope of the invention, the first leg 26 can be about ¾ of an inch long and the second leg can be about ¼ of an inch long. Additionally, there is an angle α defined between the first leg 26 and the second leg 28. Preferably, angle α is between approximately 100° and 120°, and most preferably angle α equals approximately 110°.

Referring back to FIG. 1, one example of a sheet 14 with printed information thereon is shown. In one preferred embodiment, the printed information consists of a number of word puzzles, schematically shown as 30, where each box 32 includes a single word puzzle. It is also contemplated that other types of puzzles, such as rebuses, gramograms and doodles, as well as other types of printed information, may also be displayed on the sheet 14.

If the matter printed upon the sheets 14 consists of word puzzles or other types of problems that are intended to be solved, an answer key, such as that depicted by answer key 34, as shown in FIG. 3, is preferably provided. The answer key 34 preferably includes a number of answer sheets 36 (with one sheet corresponding to each printed matter sheet 14). The answer sheets 36 are preferably attached together with a eyelet 37 that is applied to an upper corner of the answer sheets 36. Preferably, the answer key 34 is of a size that is small enough to be placed in a desk drawer (such as having 3 inch by 5 inch answer sheets), so that it can be easily stored, but yet still be readily accessible when a solution to one of the puzzles is needed. As an alternative to placing the answer key 34 in a drawer, a ring 39 may be inserted through the eyelet 37 so that the answer key can be hung upon a hook, such as one of the S-shaped hooks 48 of the hanging bar 42 described below.

One important feature of the present invention is that the sheet 14 is preferably semi-opaque and contains printed information on both sides thereof. The material used for sheet 14 should permit enough light to pass through so that if one attempts to make a photocopy of sheet 14, the light from the photocopier will be bright enough to copy the printed information from both sides onto one side of a single sheet, thereby ruining the copy (i.e., the information from the back side “bleeds through” the front side). Since such a photocopy is undesirable, this feature serves as a deterrent against unauthorized photocopies, encouraging the purchase of authorized copies of the sheets.

Although the semi-opaque sheet permits a certain amount of light to pass therethrough, the sheet should also be of a sufficient so that when placed against a wall or other solid surface, the printed material from the back side does not show through. The present inventor has found that ordinary paper is generally of a sufficient weight such that when two sheets are used together, the desired semi-opaqueness is achieved. In the alternative, a single sheet of higher quality paper can also be used in place of two sheets of lower quality paper, and the same desired effect can be achieved.

As can be seen in FIG. 1, the sheet 14 also preferably includes two holes 38 formed near the upper portion of the sheet. These two holes 38 are configured to accept the hooks 18 for mounting the sheet 14 upon the bar 16. Of course, if the sheet is small enough, a single hole may be used. Conversely, if a large sheet is utilized, more that two holes may be required to adequately position the sheet 14 upon the elongated bar 16. Preferably the holes 38 are each reinforced with a eyelet 40.

Another of the important features of the present invention is that the sheet 14 is preferably of a sufficient rigidity such that it may be grasped from the bottom and installed upon the bar 16 by a user situated well below the height of the bar. If the sheet 14 is too flimsy (or of a size that is too large for its level of rigidity), the user must grasp the sheet 14 at the top to position the eyelets 40 upon the hooks 18. Such a situation requires that the user utilize a chair or ladder to each the bar 16 (which is inconvenient and/or potentially dangerous) or that the bar 14 be positioned at a lower height that is at the user's arm level (which level may be lower than desired for adequate visibility of the sheet 14). In contrast, with the present invention, the user may position the bar 16 at a height that is equal to the height of the user's reach plus the height of the sheet 14, since the user can install the sheet upon the bar 16 by grasping the bottom of the sheet. Thus, the bar 16 can be placed at a height that is highly visible, while still allowing convenient installation of the sheet 14 upon the bar 16.

In order to give the sheet 14 the desired rigidity, it is preferably laminated on both sides of the paper. Other methods of providing adequate rigidity, such as framing the sheet in a rigid frame or providing supporting members on the frame (either in place of or in addition to the lamination) are also contemplated as being within the scope of the invention. With regard to the size of the sheet 14, a variety of sizes may be utilized, as long as the sheet is adequately rigid to enable installation by grasping the bottom of the sheet. Suggested sizes include 17 inches wide by 22 inches high and 11½ inches wide and 15½ inches high. In order to provide a clean look, it is suggested that the bar 16 be of the same width as the sheet 14 so that the ends of the bar align with the sides of the sheet. Additionally, it is suggested that the eyelets 40 be placed approximately 2 inches from the sides of the sheet 14. However, other spacing for the eyelets is also contemplated.

Turning now to FIG. 4, a preferred embodiment of a hanging bar 42 for storing the sheets 14 is shown. The hanging bar provides a convenient way of storing, in a closet, the sheets that are not being displayed, and allows the sheets to be safely stored without curling or bending, such as may occur in prior art devices in which the sheets must be rolled or where a storage system is not provided. Another advantage of the hanging bar 42 is that it stores the sheets in about the same amount of space required to hang a garment, and thus only a small amount of closet space is required.

The hanging bar 2 includes a rod 44, an upper hook 46, and two S-shaped hooks 48. The rod 44 is preferably generally cylindrical in shape, although other shapes are also contemplated. In order to avoid the need for finishing the ends of the rod 44, a rubber tip 45 may be placed upon each end. The rubber tips 45 also prevent the rod 44 from damaging the walls of the closet (or other area) where the hanging bar 2 is to be hung.

The upper hook 46 is generally J-shaped, and provides a way for the hanging bar 42 to be hung upon a horizontal pole in a closet (or upon a hook affixed to the wall or the back of a door). Preferably, the upper hook 46 includes a threaded bottom portion, and the rod 44 includes a threaded hole that is configured for receiving the threaded bottom portion of the upper hook. However, it is contemplated that the upper hook 46 may be affixed to the rod 44 in other ways, such as with a press fit.

The S-shaped hooks 48 are each configured so that a top end thereof 50 wraps around the rod 44, securing the hook to the rod, while the other end, the bottom or receiving end 52, is arranged for receiving the hole 40 of the sheets 14 being stored. Preferably, the top end 50 is secured to the rod 44 by simply compressing it around the circumference of the rod. For best results, it is suggested that the top end 50 wrap around nearly the entire circumference of the rod 44, as shown in FIG. 5. However, if less than a full circumference wrap is desired, an adhesive may also be applied to the top end 50 to ensure that the S-shaped hooks 48 are rigidly affixed to the rod 44. Additionally, the terminal end of the receiving end 52 is preferably slightly bent back upon itself, as shown in FIG. 5, to prevent the sheets being stored thereon from slipping off.

As an alternative to using S-shaped hooks, two J-shaped hooks, similar to the upper hook 46, may also be used. If two J-shaped hooks are used for receiving the sheets 14 being stored, they would be positioned in the reverse direction from the upper hook 46, but using a similar installation procedure.

In operation, the display system 10 can be hung upon a wall, via the adhesive pads 17, in a variety of different settings. The system is particularly useful in areas where people are forced to wait, such as a doctor's offices, a dentist's office, a hospital waiting room, a jury duty room, a repair shop, a school principle's office, a cafeteria, an employee lounge, etc. Using word puzzles, rebuses, gramograms or doodles in such a setting also provides the person waiting with something to do to make the wait go faster.

It is contemplated that the system will include multiple display sheets 14 so that the display sheets can be changed periodically, providing new puzzles to solve (or other visual material to view) with each new sheet. For example, the sheets could be sold in sets of six, with puzzles on both sides of each sheet, thereby providing twelve different puzzle pages—one for each month. Additional sets of display sheets, as well as additional hanging bars, could also be purchased separately.

While one sheet 14 is being displayed upon the mounting fixture 12, the remaining sheets of the set can be stored in a closet (or other suitable area) upon the hanging bar 42. As mentioned above, the hanging bar 42 is specifically designed so that it only occupies about the same amount of space as a garment hung in a closet, but yet it safely stores the sheets so that they will not curl or otherwise be damaged.

While particular embodiments of the mounting fixture, the display sheets and the hanging bar have been shown and described, it will be appreciated by those skilled in the art that changes and modifications may be made thereto without departing from the invention in its broader aspects and as set forth in the following claims.

What is claimed is:

1. A mounting fixture for displaying a sheet including printed information thereon, said mounting fixture comprising:
an elongated bar including a front surface, a rear surface and two end surfaces;
means for attaching said elongated bar to a wall; and
a plurality of hooks attached to said front surface of said elongated bar, each of said hooks being generally L-shaped.

2. The mounting fixture according to claim 1, wherein said attaching means is affixed to said rear surface of said elongated bar.

3. The mounting fixture according to claim 2, wherein:
said plurality of hooks includes only two hooks;
said attaching means includes only two attaching members; and
each of said hooks is positioned to directly oppose one of said attaching members.

4. The mounting fixture according to claim 1, wherein each of said generally L-shaped hooks includes a first portion that extends in a generally horizontal direction and a second portion that extends in a generally vertical direction.

5. The mounting fixture according to claim 4, wherein an angle defined between said first portion of said hook and said second portion of said hook is greater than 90°.

6. The mounting fixture according to claim 5, wherein said angle defined between said first portion and said second portion is approximately within the range of 100° and 120°.

7. The mounting fixture according to claim 1, wherein said attaching means comprises at least one double-sided adhesive pad.

8. The mounting fixture according to claim 1, wherein said printed material includes at least one of the following: word puzzles, rebuses, gramograms, and doodles.

9. A system for displaying printed information, said system comprising:
a relatively rigid sheet including the printed information thereon and a plurality of holes therein;
an elongated bar including a front surface, a rear surface and two end surfaces;
means for attaching said elongated bar to a wall; and
a plurality of hooks attached to said front surface of said elongated bar, wherein each of said hooks is positioned to correspond to one of said holes in said sheet.

10. The system as defined in claim 9, wherein each of said hooks is generally L-shaped.

11. The system as defined in claim 10, wherein each of said generally L-shaped hooks includes a first portion that extends in a generally horizontal direction and a second portion that extends in a generally vertical direction, and further wherein an angle defined between said first portion and said second portion is approximately within the range of 100° and 120°.

12. The system as defined in claim 9, wherein said relatively rigid sheet comprises a laminated sheet.

13. The system as defined in claim 9, wherein said relatively rigid sheet includes printed information on both sides thereof.

14. The system as defined in claim 13, wherein said relatively rigid sheet is semi-opaque so that if photocopied, printed information from both sides is visible in the photocopy, in order to deter unauthorized photocopying of said relatively rigid sheet.

15. The system as defined in claim 9, wherein:
said relatively rigid sheet includes holes positioned near a top thereof; and
said relatively rigid sheet is of a size and rigidity such that it can be grasped by a user from a single area near a bottom thereof for facilitating positioning of said relatively rigid sheet upon said hooks of said elongated bar, even when the user is located well below the location of said elongated bar.

16. The system as defined in claim 15, wherein said holes each include an eyelet therein.

17. The system as defined in claim 9, wherein said printed information includes at least one of the following: word puzzles, rebuses, gramograms, and doodles.

18. The system as defined in claim 9, wherein the wall upon which said elongated bar is attached is located in a waiting room.

19. The system as defined in claim 9, wherein the wall upon which said elongated bar is attached is located in a medical professional's examination room.

20. The system as defined in claim 9, wherein the wall upon which said elongated bar is attached is located in a school.

21. A hanging bar for storing sheets including printed information thereon, wherein each of the sheets includes at least two holes therein, said system comprising:
a rod;
an upper hook extending upwardly from said rod, said upper hook being configured and arranged for hanging the hanging bar upon a horizontal pole within a closet; and
at least two generally S-shaped hooks attached to said rod, said generally S-shaped hooks being configured and arranged for receiving thereon a plurality of the sheets of printed material via the at least two holes formed in each of the sheets.

22. The hanging bar according to claim 21, wherein said upper hook is generally J-shaped.

23. The hanging bar according to claim 22, wherein:
said generally J-shaped upper hook is threaded on one end thereof; and
said rod includes a threaded hole configured to receive said threaded end of said generally J-shaped upper hook.

24. The hanging bar according to claim 21, wherein each of said S-shaped hooks extends over a top portion of said bar such that a receiving end of each of said S-shaped hooks extends from one side of said bar.

25. The hanging bar according to claim 24, wherein said rod is generally cylindrical in shape.

26. A system for displaying and storing sheets including printed information thereon, said system comprising:
a plurality of relatively rigid sheets including the printed information thereon;
a mounting fixture for displaying at least one of said relatively rigid sheets, said mounting fixture including:
an elongated bar including a front surface, a rear surface and two end surfaces;
means for attaching said elongated bar to a wall; and
a plurality of hooks attached to said front surface of said elongated bar;
a hanging bar for storing said relatively rigid sheets not being displayed on said mounting fixture, said hanging bar including:
a rod;
an upper hook extending upwardly from said rod, said upper hook being configured and arranged for hanging the hanging bar upon a horizontal pole within a closet; and.
at least two generally S-shaped hooks attached to said rod, said generally S-shaped hooks being configured and arranged for receiving thereon said relatively rigid sheets not being displayed.

27. The system according to claim 26, wherein:
the printed material includes at least one of the following: word puzzles, rebuses, gramograms, and doodles; and
the system also includes an answer key with answers to the printed material.

28. The system according to claim 27, wherein said answer key includes:
a plurality of answer sheets that are affixed together with a eyelet; and
a ring extending through said eyelet.

29. The system according to claim 26 wherein:
each of said plurality of hooks is generally L-shaped and includes a first portion that extends in a generally horizontal direction and a second portion that extends in a generally vertical direction; and
further wherein an angle defined between said first portion and said second portion is greater than 90°.

30. The system according to claim 26, wherein each of said S-shaped hooks extends over a top portion of said hanging bar such that a receiving end of each of said S-shaped hooks extends from one side of said hanging bar.

31. The system according to claim 26, wherein each of said relatively rigid sheets includes printed information on both sides thereof, and further wherein each of said relatively rigid sheets is semi-opaque so that if photocopied, printed information from both sides is visible in the photocopy, in order to deter unauthorized photocopying of said relatively rigid sheets.

32. The system according to claim 26, wherein:
each of said relatively rigid sheets includes two holes near a top thereof;
said mounting fixture includes two of said hooks positioned for receiving said two holes in each of said relatively rigid sheets; and
further wherein each of said relatively rigid sheets is of a size and rigidity such that it can be grasped by a user from a single area near a bottom thereof for facilitating positioning of said relatively rigid sheet upon said hooks of said mounting fixture, even when the user is located well below the location of said mounting fixture.

33. The system according to claim 32, wherein each of said relatively rigid sheets comprises a laminated sheet.

34. The system according to claim 26, wherein:
said plurality of hooks includes only two hooks;
said attaching means includes only two attaching members; and
each of said hooks is positioned to directly oppose one of said attaching members.

35. The system according to claim 26 wherein the wall upon which said elongated bar is attached is located in a waiting room.

36. The system according to claim 26 wherein the waiting room is part of a medical professional's office.
